(19) United States
(12) Patent Application Publication
(10) Pub. No.: US 2007/0137032 A1
(43) Pub. Date: Jun. 21, 2007

(54) Ground stud installation on composite structure for electrostatic charges

(76) Inventors: Stephen M. Braden, Everett, WA (US); John R. Porter, Lynnwood, WA (US); Nick I. Tavernarakis, Lynnwood, WA (US)

Correspondence Address: KLEIN, O'NEILL & SINGH, LLP, 43 CORPORATE PARK, SUITE 204, IRVINE, CA, 92606, US

(21) Appl. No.: 11/304,858

(22) Filed: Dec. 15, 2005

(51) Int. Cl. H01R 43/00

(52) U.S. Cl. 29/825; 29/837; 29/844; 29/868; 29/842

(57) ABSTRACT

Method and system for installing a ground stud on composite material. The method includes securing the ground stud to the composite material creating an electrical contact between the ground stud and composite material; and attaching a connective device to the ground stud for allowing current to flow from the connective device to the ground stud and then into the composite material. The system includes a ground stud with a conductive pin having, a first end for attaching the ground stud to a composite material such that the pin makes electrical contact with carbon fibers within the composite material, and a second threaded end for connection to a self locking nut securing the ground stud to a composite material; and a connective device with a conductive terminal which fits on top of the ground stud allowing current to flow from the connective device to the ground stud and the composite material.

### BACKGROUND OF THE INVENTION

1. Field of the Invention

The present invention relates to installing ground studs and more particularly, to installing ground studs to composite materials

2. Background

In electronic and electrical equipment, conductive surfaces must be grounded. A ground is a direct electrical connection to the earth, a connection to a particular point in an electrical or electronic circuit, or an indirect connection that operates as the result of capacitance between wireless equipment and the earth or a large mass of conductive material. Electrical grounding is important because it provides a reference voltage level (typically referred to as zero potential or ground potential) against which all other voltages in a system are established and measured.

An effective electrical ground connection also minimizes the susceptibility of equipment to interference, reduces the risk of equipment damage due to lightning, eliminates electrostatic buildup that can damage system components, and helps protect personnel who service and repair electrical, electronic, and computer systems. In effect, an electrical ground drains away any unwanted buildup of electrical charge. When a point is connected to a proper ground that point tends to stay at a constant voltage, regardless of what happens elsewhere in the circuit or system. The earth, which forms the ultimate ground, has the ability to absorb or dissipate an unlimited amount of electrical charge.

A ground can also be a connection to the main chassis of a piece of electronic or electrical equipment. In older appliances and in desktop computers, this is a metal plate, usually copper or aluminum. In some modern equipment, it is a foil run on the main printed circuit board, usually running around the periphery. It provides a point that can be considered to have zero voltage. All other circuit voltages (positive or negative) are measured or defined with respect to it. Ideally, all chassis grounds should lead to earth grounds.

If the electronic or electrical device is not grounded, electrostatic and precipitation static charges cannot bleed off and can develop to high levels causing either sparking around flammable areas or static arching and noise which will appear on communication equipment. As such, it is important to ensure all electronic an electrical devices are grounded. As technology advances, some new materials lack a good electrical connection, thus making it difficult to ground the system.

Currently composite materials are beginning to be used in an increasing number of products ranging from simple consumer goods to advanced aerospace structures, such as airplanes. Although composite materials are conductive to some degree, they cannot achieve good electrical connection by incidental contact due to non-conductive outer surface layers of the composite build up. (Composite materials consist of two or more materials.) Therefore, what is needed is a system and method for installing a ground stud to composite materials to achieve low resistance grounding and achieve good electrical connections.

### SUMMARY OF THE INVENTION

In one aspect of the present invention, a method for installing a ground stud on composite material is provided. The method includes drilling a hole in the composite material; securing the ground stud to the composite material creating an electrical contact between the ground stud and the composite material; and attaching a connective device to the ground stud for allowing current to flow from the connective device to the ground stud and then into the composite material.

In another aspect of the present invention a ground stud system is provided. The system includes a ground stud with a conductive pin having, a first threaded end for attaching the ground stud to a composite material such that the pin makes electrical contact with carbon fibers within the composite material, and a second end for connection to a self locking nut securing the ground stud to a composite material; and a connective device with a conductive terminal which fits on top of the ground stud allowing current to flow from the connective device to the ground stud and the composite material.

This brief summary has been provided so that the nature of the invention may be understood quickly. A more complete understanding of the invention can be obtained by reference to the following detailed description of the preferred embodiments thereof in connection with the attached drawings.

### BRIEF DESCRIPTION OF THE DRAWINGS

The foregoing features and other features of the present invention will now be described with reference to the drawings of a preferred embodiment. In the drawings, the same components have the same reference numerals. The illustrated embodiment is intended to illustrate, but not to limit the invention. The drawings include the following Figures:

FIG. 1 illustrates a ground stud utilized in a preferred embodiment of the present invention;

FIG. 2 illustrates a ground stud installed on a composite material/structure in a preferred embodiment of the present invention;

FIG. 3 illustrates an exploded view of the ground stud system in a preferred embodiment of the present invention;

FIG. 4 illustrates an electrical current flow from a connection device to a composite material in a preferred embodiment of the present invention;

FIG. 5a illustrates a top view of the ground stud system of the present invention; and

FIG. 5b illustrates a bottom view of the ground stud system of the present invention.

### DETAILED DESCRIPTION OF THE PREFERRED EMBODIMENTS

The following detailed description is of the best currently contemplated modes of carrying out the invention. The description is not to be taken in a limiting sense, but is made merely for the purpose of illustrating the general principles of the invention, since the scope of the invention is best defined by the appended claims.

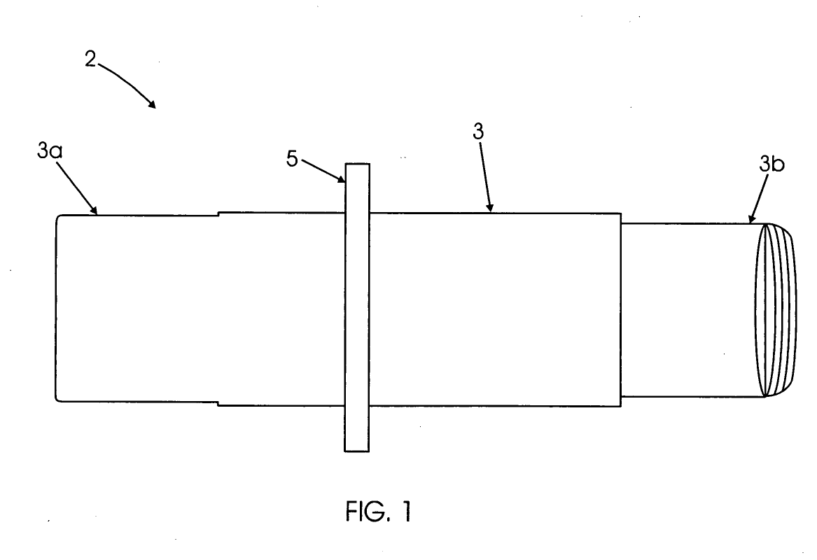

FIG. 1 illustrates a ground stud 2, such as a hi-lock fastener, utilized in a preferred embodiment of the present invention. Ground stud 2 is comprised of a pin 3, having a first threaded end 3a and a second end 3b, and a shoulder 5. A coating, such as aluminum pigmented coating, is applied to both ends 3a and 3b of pin 3 for easier installation of self locking nut 8 and collar 12 (See FIG. 3). The coating applied on first threaded end 3a does not completely cover first threaded end 3a, leaving a space of 0.100+0.030/−0.000 above shoulder 5 uncoated, which ensures electrical conductivity between conductive terminal 13 and shoulder 5 of ground stud 2. In addition to providing easier installation, the coating also protects against corrosion and provides a lubricant for making installation with power tools easier as the self locking nut 8 and collar 12 will not seize to ground stud 2.

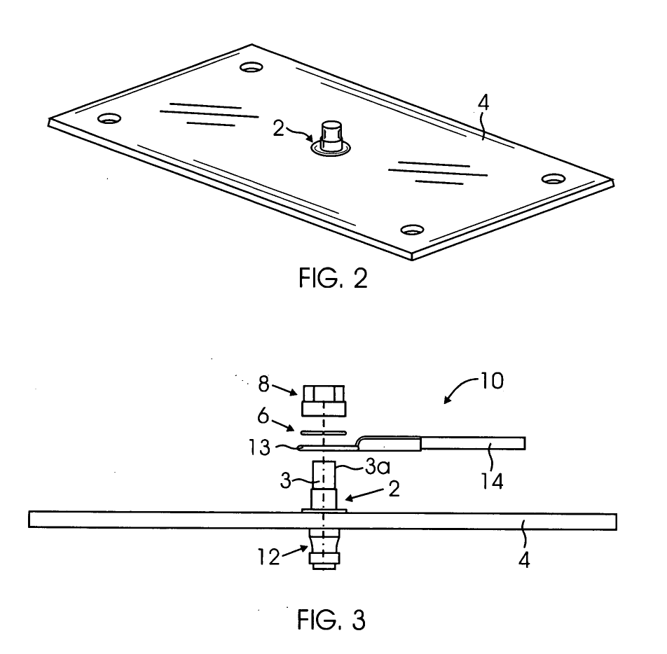

FIG. 2 illustrates ground stud 2 installed in a composite structure or material in a preferred embodiment of the present invention. Ground stud 2 is installed in composite material 4 so that the connection between the conductive fibers (i.e. carbon fibers) in composite material 4 and pin 3 results in low electrical bonding resistance between ground stud 2 and composite material 4. Ground stud 2 then provides an attachment point for electrical connections to composite material 4 using a connection device 14, such as a bonding jumper, wire, or other type of conductive connector.

To install ground stud 2 in composite material 4, a hole, having a diameter less than 0.002 inches larger than pin 3, is drilled in composite material 4, and then ground stud 2 is inserted into the hole. An electrical bonding resistance of less than 1 ohm is initially achieved and maintained through the defined life of the device made of composite material 4. The resistance level of less than 1 ohm meets the electrical bonding requirement for being able to bleed off electrostatic or precipitation type of charges.

Turning to FIG. 3, an exploded view of a ground stud system 10 of the present invention is shown. As discussed above, ground stud 2 is placed through a predrilled hole in composite material 4 and secured to the bottom of composite material 4 with a collar 12. Pin 3 of ground stud 2 makes electrical contact with carbon fibers within composite material 4, and first threaded end 3b for connection to collar 12 securing ground stud 2 to composite material 4. Pin 3 is made of an electrically conductive material that will not electro-chemically react to carbon fiber. Electrically conductive materials, such as titanium and steel, can be used.

Connective device 14 comprises conductive terminal 13 which fits on top of ground stud 2 allowing electro static current to flow from connective device 14 to ground stud 2 and composite material 4. A pressure washer 6 and self-locking nut 8 are placed on top of conductive terminal 13 securing connective device 14 to ground stud 2.

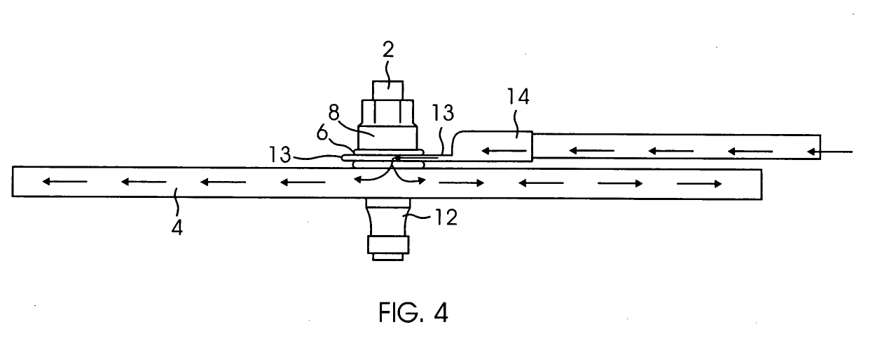

FIG. 4 illustrates how electrical current flows from connection device 14 to composite material 4 in a preferred embodiment of the present invention. An electrical current is introduced into connection device 14 causing the electrical current to flow through connection device 14 to conductive terminal 13 which is in contact with shoulder 5 of ground stud 2. Shoulder 5 is in electrical contact with pin 3 which is in electrical contact with carbon fibers within composite material 4 resulting in a good electrical connection with composite material 4.

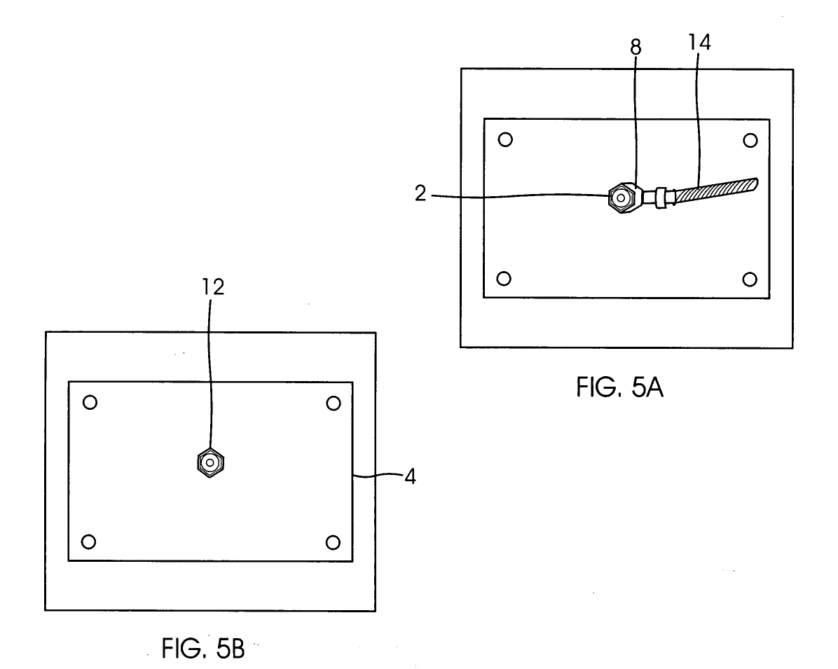

Top and bottom views of the ground stud system of the present invention are illustrated in FIGS. 5a and 5b respectively.

Although the present invention has been described with reference to specific embodiments, these embodiments are illustrative only and not limiting. Many other applications and embodiments of the present invention will be apparent in light of this disclosure and the following claims.

This listing of claims will replace all prior versions and listings of claims in the application:

1. A method for installing a ground stud on composite material, comprising:
Drilling a hole in the composite material for the ground stud, wherein the ground stud includes a pin having a shoulder between a first threaded end and a second threaded end; and wherein the diameter of the hole is larger than the diameter of the pin;
Inserting the ground stud in the hole, wherein pin is in electrical contact with carbon fibers within the composite material, creating an electrical bonding resistance of less than 1 ohm;
Securing the ground stud to the composite material creating an electrical contact between the ground stud and the composite material; and
Attaching a connective device to the shoulder of the ground stud for allowing current to flow from the connective device to the ground stud and then into the composite material.

2. (canceled)

3. (canceled)

4. The method of claim 1, wherein the first threaded end and the second threaded end are coated.

5. The method of claim 1, wherein the pin is made of electrically conductive material that will not electro-chemically react to carbon fiber.

6. The method of claim 1, wherein the pin is made of titanium.

7. The method of claim 1, wherein the pin is made of steel.

8.-12. (canceled)

13. The method of claim 1, wherein the ground stud is secured to the composite material by screwing a self locking nut onto the second threaded end.

14. A method for manufacturing a composite structure including composite material having carbon fibers, the method comprising:
installing a ground stud in the composite material such that the ground stud is in electrical contact with the carbon fibers of the composite material with an electrical bonding resistance of less than 1 ohm; and
attaching a conductive connector to the ground stud such that the conductive connector is electrically connected to the composite material through the ground stud.

15. The method of claim 14, wherein the installing step further comprises installing the ground stud in a hole formed in the composite material wherein the hole has a diameter that is larger than a diameter of the ground stud.

16. The method of claim 15, wherein the hole is a through hole, the installing step further comprising securing the ground stud to the composite material such that the electrical bonding resistance of less than 1 ohm is maintainable through the defined life of the composite structure.

17. The method of claim 14, wherein the installing step further comprises installing a ground stud made from an electrically conductive material that is non-electro-chemically reactive to the carbon fiber of the composite material.

18. The method of claim 14, wherein the installing step further comprises installing a ground stud including titanium.

19. The method of claim 14, wherein the attaching step further comprises attaching a conductive connector including a bonding jumper.

20. A composite structure manufactured by:
installing a ground stud in the composite material such that the ground stud is in electrical contact with the carbon fibers of the composite material with an electrical bonding resistance of less than 1 ohm; and
attaching a conductive connector to the ground stud such that the conductive connector is electrically connected to the composite material through the ground stud.

21. A method of electrically connecting a conductive connector to a composite structure including composite material having carbon fibers, the method comprising:
securing an electrically conductive ground stud to the composite material such that:
the ground stud is in electrical contact with the carbon fibers of the composite material with an electrical bonding resistance of less than 1 ohm; and
the electrical bonding resistance of less than 1 ohm is maintainable through the defined life of the composite structure; and
attaching a conductive connector to the ground stud such that the conductive connector is electrically connected to the composite material through the ground stud.

22. The method of claim 21, wherein the securing step further comprises securing the ground stud in a hole formed in the composite material wherein the hole has a diameter that is larger than a diameter of the ground stud.

23. The method of claim 21, wherein the securing step further comprises securing a ground stud made from an electrically conductive material that is non-electro-chemically reactive to the carbon fiber of the composite material.

24. The method of claim 23, wherein the securing step further comprises securing a ground stud including titanium.

25. The method of claim 21, wherein the attaching step further comprises attaching a conductive connector including a bonding jumper.

26. The composite structure electrically connected to a conductive connector by:
securing an electrically conductive ground stud to the composite material such that:
the ground stud is in electrical contact with the carbon fibers of the composite material with an electrical bonding resistance of less than I ohm; and
the electrical bonding resistance of less than 1 ohm is maintainable through the defined life of the composite structure; and
attaching a conductive connector to the ground stud such that the conductive connector is electrically connected to the composite material through the ground stud.
